(19) United States
(12) Patent Application Publication
(10) Pub. No.: US 2019/0009653 A1
(43) Pub. Date: Jan. 10, 2019

(54) VEHICLE OPEN-WINDOW COVER WITH PET VISIBILITY

(71) Applicant: Dashon Alan Johnson, San Diego, CA (US)

(72) Inventor: Dashon Alan Johnson, San Diego, CA (US)

(21) Appl. No.: 15/861,579

(22) Filed: Jan. 3, 2018

Related U.S. Application Data
(63) Continuation-in-part of application No. 29/629,687, filed on Dec. 14, 2017.
(60) Provisional application No. 62/498,614, filed on Jan. 3, 2017.

(51) Int. Cl. B60J 1/20; E06B 7/28

(52) U.S. Cl. CPC B60J 1/20; B60R 2021/028; E06B 7/28

(57) ABSTRACT

The present invention provides safe, easy way for a pet to see out the window of a vehicle. In an embodiment of the invention, a vehicle window cover made of inelastic material with visibility openings fits over an entire rear vehicle window from the top of the door to the bottom of the window panel by sliding over the top of the door when it is open, thus being securely fixed to the window upon opening the door. The covering is a bag-like, panel that allows a pet to see out by peering through an opening or openings that correspond to its height in the panel, thus allowing a pet to stand at the window or sit on a booster seat and look out of an opening while exposing only its head and ears.

### CROSS REFERENCE TO RELATED APPLICATION

This present invention claims priority to U.S. Provisional Patent Application No. 62/498,614, filed on Jan. 3, 2017, and entitled, “Vehicle Window Cover with Pet Visibility;” and U.S. Design Pat. Application No. 29/629,687, filed on Dec. 14, 2017, entitled, “Vehicle Open-Window Cover with Pet Visibility,” the disclosures of which are incorporated by reference herein in its entirety.

### BACKGROUND OF THE INVENTION

### 1. Field of Invention

The present invention relates to vehicle open-window coverings designed for pets or animals.

### 2. Description of Related Art

Sixty-eight percent of American households have a pet, according to 2017-18 American Pet Product Association National Pet Owners Survey. What is significant about U.S. pet owners today is not only are they convinced pets are good for their health—81 percent say so—but they are less likely to be separated from them, taking them on vacation, to work, to pet-friendly restaurants, shopping malls and even grocery stores. All this traveling to and fro usually requires a ride in a vehicle. An important consideration for owners today, often dog owners, is traveling safely. The days of piling kids and the family dog in the back of a pickup truck or stationwagon are over. Organizations such as the American Humane Association recommend travel protocol for pets, including warnings against rides in open truck beds and cars with open windows.

With an interest in safety, manufacturers have developed a host of products to aid traveling pets and owners. Like seatbelts in cars for people, there are various types of restraints and tethers for pets; a harness, for example, that fastens around a dog's body, which is in turn secured to an existing seatbelt. Or a travel crate that can be placed or secured on a seat or in a cargo area, as well net and metal barriers designed to keep pets confined in one section of a vehicle.

Window-related products have an interesting niche in the pet marketplace, perhaps because owners who enjoy the sights and fresh air think their animal travel companions will, too. Car booster seats, for example, allow small dogs to sit high enough to look out the window. Or wire mesh panels allow an open window for cooling while keeping the pet securely inside.

Though they do not allow an open window, mesh window shades with suction attachment are popular with pet owners, as well as parents of young children. Additionally, the stretch mesh window cover, used for shade or temporary protection for a broken or unusable vehicle window, does allow for an open window. However, visibility and outside access is impeded. A need exists, therefore, for a stretch mesh window cover that allows visibility and pet access to the outside through the window while at the same time preventing the pet from leaving the vehicle.

### SUMMARY OF THE INVENTION

The present invention overcomes this and other deficiencies of prior art by providing a safe, easy way for a pet to see out the window of a vehicle. In an embodiment of the invention, a pet-accessible vehicle window covering is formed to fit over a window of a vehicle. The vehicle window covering comprises inelastic inside and outside fabric surfaces joined at an edge that aligns with the top and side edges of a vehicle window frame. An elastic band is provided at the bottom of the window covering, which allows the window covering to expand over the vehicle window frame during installation. A drawstring is provided to cinch the window covering tight against the vehicle window frame at the top and side edges. An opening is formed through the inside and outside surfaces of the window covering. A surrounding border of the opening is inelastic to allow a head of a pet to pass through, but to prevent the pet's body from passing through.

In an embodiment of the invention, a vehicle window covering comprises: an inside surface and an outside surface, wherein the inside surface and the outside surface are joined together at a top and side sections of a perimeter edge of the inside surface and the outside surface; an elastic band adjoined to a bottom section of the perimeter edge of the inside surface and the outside surface; and the inside surface and the outside surface each having an opening therethrough. The vehicle window covering of claim 1 further comprises a drawstring located at the atop and side sections of the perimeter edge, the drawingstring extending past the elastic band, and further including one or more drawstring locks. A surrounding border of the outside surface's opening is reinforced. A flap is adjoined to a surrounding border of the outside surface's opening. The outside surface's opening is positioned at a face of a character displayed on the outside surface. A ring can be adjoined to a surrounding border of the outside surface's opening. The inside surface and the outside surface are inelastic fabric.

In another embodiment of the invention, a method of covering a vehicle window, comprises the steps of: placing a covering over a vehicle window door frame in its open position, the covering comprising an inside surface and an outside surface joined together at a top and side sections of a perimeter edge of the inside surface and the outside surface, and an elastic band adjoined to a bottom section of the perimeter edge of the inside surface and the outside surface, the inside surface and the outside surface each having an opening therethrough; aligning the bottom section of the perimeter edge with a bottom section of a window of the vehicle window door frame; cinching the top and side sections of the perimeter edge of the inside surface and the outside surface against the vehicle window door frame;positioning the vehicle window door frame to a closed position; and lowering the vehicle window to an open position. The step of cinching comprises tightening a drawstring located at the atop and side sections of the perimeter edge, the drawingstring extending past the elastic band, and further including one or more drawstring locks. The method may further comprise the step of covering the outside surface's opening or decreasing a size of the outside surface's opening. The inside surface and the outside surface are inelastic fabric.

An advantage to the present invention is it provides a fun and easy way for a pet to see out a vehicle window, thus adding to a pet owner's enjoyment knowing he or she is providing safe and interesting travels for an animal companion.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, and the advantages thereof, reference is now made to the ensuing descriptions taken in connection with the accompanying drawings briefly described as follows:

FIG. 1 is a perspective view of the pet-accessible vehicle window covering according to an embodiment of the invention.

FIG. 2 is a perspective view of the pet-accessible vehicle window covering of FIG. 1 installed in an exemplary vehicle window according to an embodiment of the invention.

FIG. 3 is a right view of the pet-accessible vehicle window covering as shown in FIG. 1.

FIG. 4 is a left view of the pet-accessible vehicle window covering as shown in FIG. 1.

FIG. 5 is a top view of the pet-accessible vehicle window covering as shown in FIG. 1.

FIG. 6 is a bottom view of the pet-accessible vehicle window covering as shown in FIG. 1.

FIG. 7 is a front-side view of the pet-accessible vehicle window covering as shown in FIG. 1.

FIG. 8 is a back-side view of the pet-accessible vehicle window covering as shown in FIG. 1.

FIG. 9 illustrates an interior view of the vehicle window cover with visibility according to an embodiment of the invention.

FIG. 10 illustrates an exterior view of the vehicle window cover with visibility according to an embodiment of the invention.

### DETAILED DESCRIPTION OF EMBODIMENTS

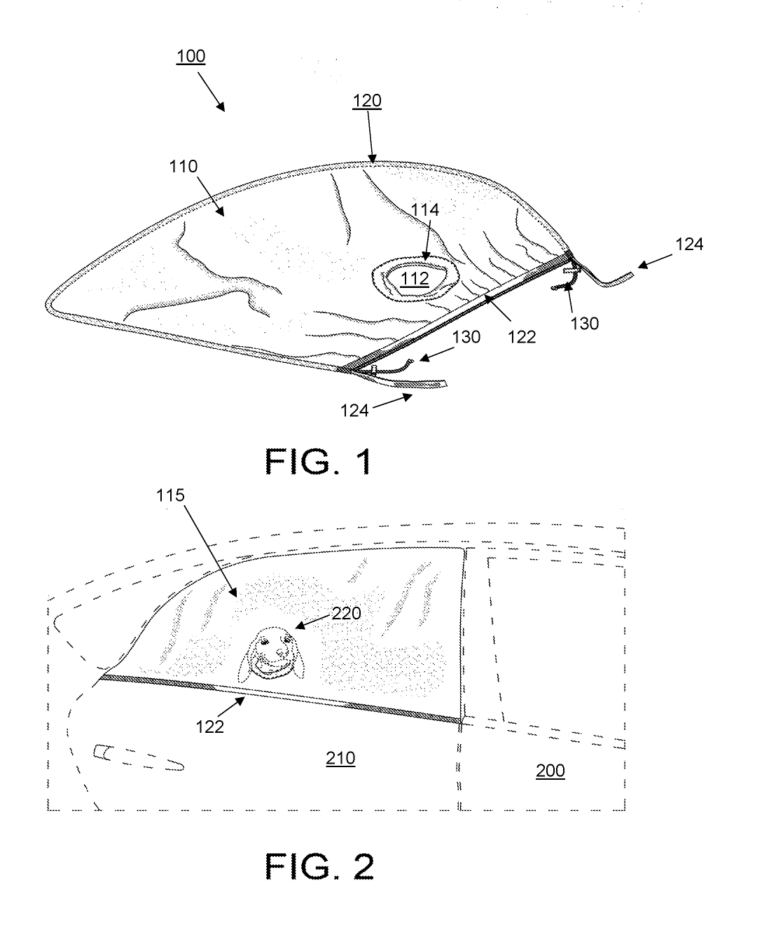

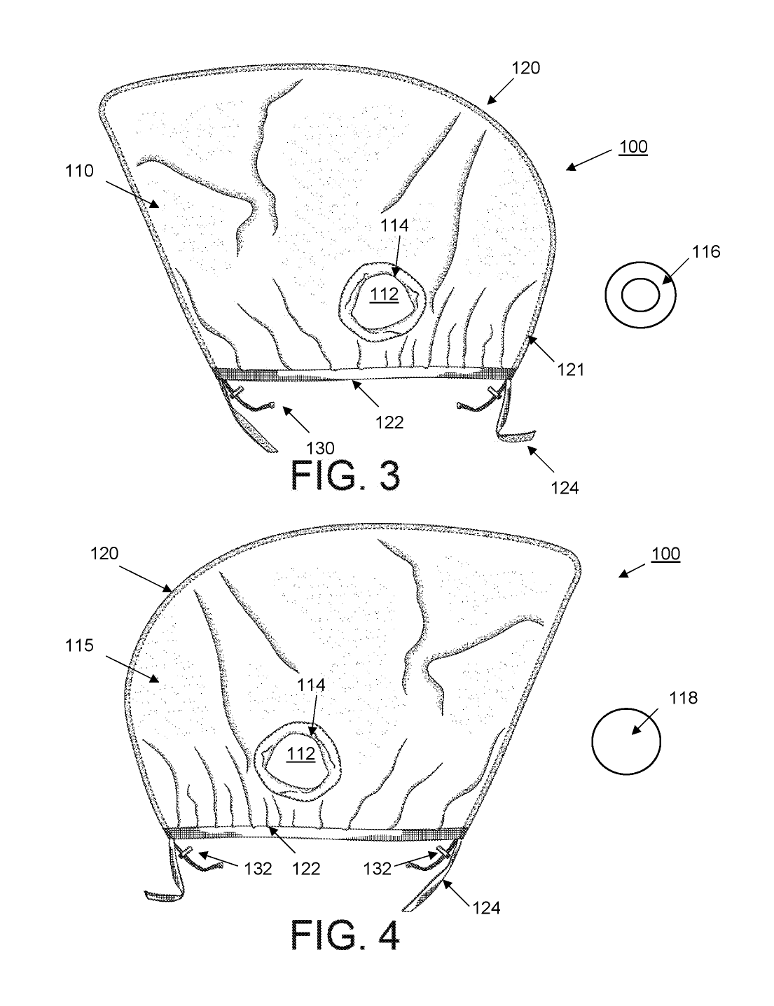

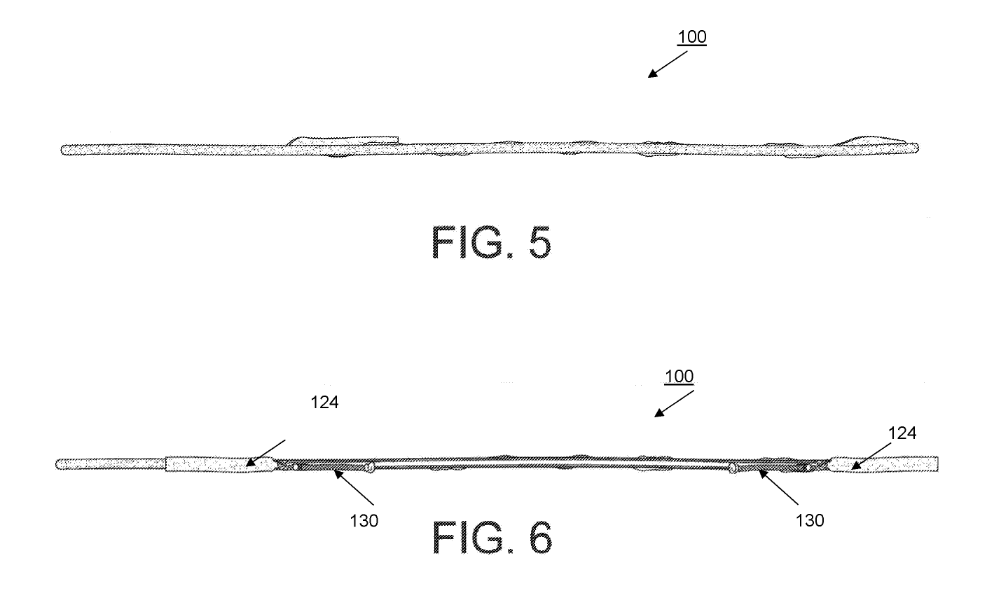

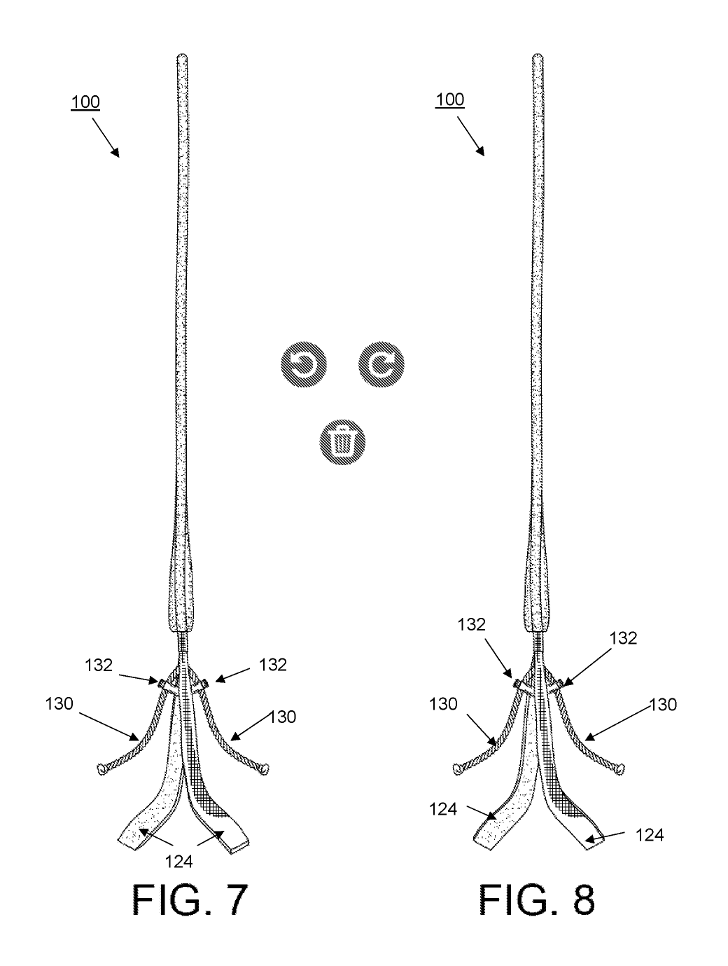

Preferred embodiments of the present invention and their advantages, as well as the operation of various embodiments of the invention are described in detail below with reference to the accompanying FIGS. 1-10, wherein like reference numerals refer to like elements. Although the invention is described in the context of a car window covering for a dog, the present invention can be implemented on any type of vehicle including, but not limited to trucks, buses, vans, mini-vans, sport-utility vehicles, pickups, recreational vehicles, limousines, trailers, boats, planes, and trains, and can be used by any type of animal including, but not limited to cats, birds, horses, sheep, pigs, goats, and monkeys.

The present invention provides a pet-accessible vehicle window covering. The window covering comprises a resilient and tough cover, which is placed over a window portion of a car door much like a sock or sleeve. The car window may still be operated between open and closed states. An opening is provided through the cover and sized to fit a respective dog's head, but not its body. With the car window in an open state, the opening of the cover allows the dog's head to pass through, up to its neck, prosternum, shoulders, chest, and/or withers, but prevents the remaining body to pass through. That way, the dog can “stick” its head out the car window, while assuring the owner or driver that the dog will not jump/fall through the window.

FIGS. 1-8 illustrate various views of a pet-accessible vehicle window covering 100 according to an embodiment of the invention. Covering 100 comprises an inside surface 110 and an outside surface 115, which are joined together together at edge 120. In an embodiment of the invention, the inside surface 110 and outside surface 115 are two similarly shaped pieces of fabric stitched together at edge 120. Alternatively, the inside surface 110 and outside surface 115 are formed from one piece of fabric folded onto themselves. Inside surface 110 and outside surface 115 each include an opening 112 having a surrounding border 114. The surrounding border 114 may be reinforced in the form of a hem, the types of which are apparent to one of ordinary skill in the art, and may include additional inelastic material. For example, the hem is formed from a ring shaped piece of fabric folded along a center with each outer edge sewn to a respective inside surface 100 or outside surface 115 as shown. Inside surface 110 and outside surface 115 are preferably a non-stretch fabric material or substantially inelastic material such as, but not limited polyester, cotton, or denim. Polyester is preferable because it allows for a minimal amount of stretch to keep the product fitted to any size car door, but is also ideal for sublimation printing of artwork. A non-stretch fabric, particularly at the surrounding border 114, prevents a dog from falling or passing through the opening 112 and also from overly distorting the surfaces 110 and 115, e.g., expanding the cover 100 outside the window 200 of a car door to effectively allow the dog's body to pass through the window 200 (even though it may still still restained from passing through the opening 112). For purposes of this disclosure, inelastic does not mean perfectly inelastic. The non-stretch fabric may have a minimal amount of give.

An elastic band 122 is provided at the bottom edge of the covering 100. The elastic band 122 provides an expandable opening at the bottom by which the covering may be installed over the car window 200. A drawstring 130 is provided through the edge 120 to cinch the covering tight over the window 200 after installation. For example, a stitch 121 adjoining the inside surface 110 and the outside surface 115 is provided near the edge 120 to form a channel by which the drawstring 130 may pass through. The drawstring 130 includes a single hole plastic toggle spring stop 132 at each end outside the channel. Straps 124 are provided to secure the covering 100 to the car door 210. For example, straps 124 are loops of a Velcro attachment. The hooks of the Velcro attachment would me mounted on an inside panel of the car door via an adhesive, the identification and implementation of which is apparent to one of ordinary skill in the art. Accordingly, the straps 124 prevent the covering 100 from rotating about the car door 210. In an embodiment of the invention, the elastic band 122 comprises a braided elastic, knit elastic, or cord elastic, the implementation of which is apparent to one of ordinary skill in the art.

Installation of the covering 100 over a window 200 is relatively simple. First, the covering 100 is placed over the window 200 through the expanded opening provided by stretching the elastic band 122. Once the stretched elastic band 122 is aligned with a bottom edge of the window 200, each end of the draw string 132 is pulled tight and the toggle spring stops 132 are locked into place. The edge 120 must be aligned with the outer edges of the window 200, and the openings 112 of the inside surface 110 and outside surface 115 must be aligned.

As shown in FIG. 2, once the covering 100 is installed over the window 200, the window itself is lowered into an open position so that a head of a dog 220 may pass through the openings 112, up to its neck, prosternum, shoulders, chest, and/or withers. The inelastic border 114 prevents the remaining body to pass through. Thus, the dog 220 may stand at the window 200 or sit on a booster seat and look out of the opening 112 while exposing only its head and ears.

The openings 112 may vary in size to accommodate different sized dogs. For example, a larger opening 112 may be used for a bull mastiff. A smaller opening 112 may be used for a shitzu. In an embodiment of the invention, a ring of inelastic fabric 116 may be attached to the surrounding border 114 via Velcro to decrease the size of an opening 112. For example, the ring of inelastic fabric would have an inner diameter less than the inner diameter of the surrounding border 114. In another embodiment of the invention, a disc of fabric 118 may be attached to the surround border 114 via Velcro to completely enclose the opening 112. For example, the disc of fabric may be used when a dog is not present. Also, if a dog is not present, the window 200 may be raised and lowered without interference by the covering 100.

In yet another embodiment of the invention, the height of the openings 112 may vary to accommodate different sized dogs. For example, a shitzu owner may prefer an opening 112 at the bottom of the covering 100, while a bull mastiff owner may prefer an opening 112 closer to the top of the covering 100. Multiple openings 112 may be implemented as well.

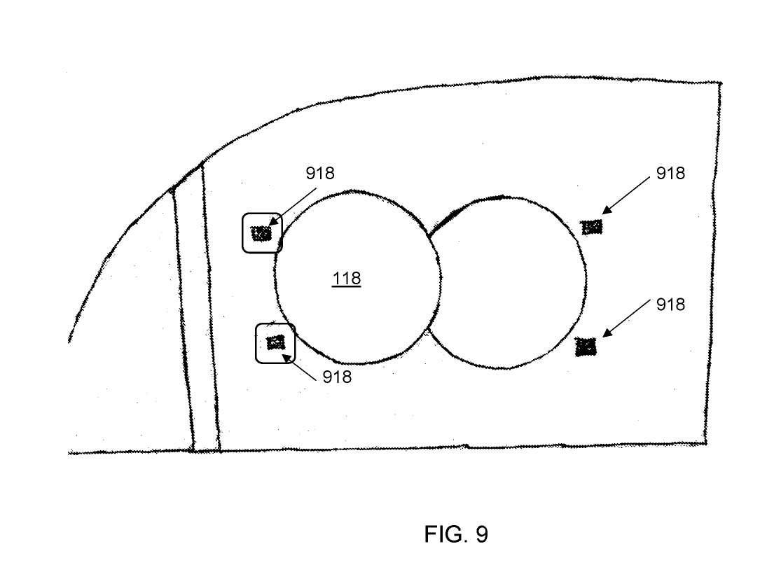

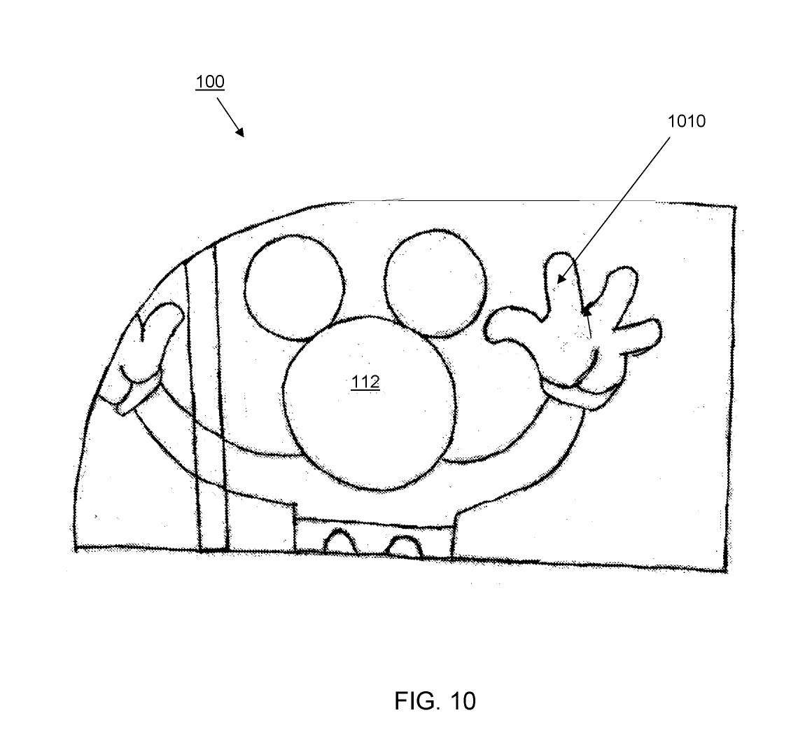

In another embodiment of the invention as shown in FIG. 9, the disc 118 (or ring 116) may be permanently adjoined to a portion 910 of the surrounding border 114 such that it acts as a flap. The disc 118 includes Velcro fasteners 918 to secure the flap into an open or closed position. FIG. 9 shows the flap in an open position.

As shown in FIG. 10, the covering 100 may include artwork 1010 on the outside surface 115 surrounding the opening 112. For example, the artwork 1010 may include a picture of a character (e.g., Mickey Mouse) where the face of the character is positioned as the opening 112.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A vehicle window covering comprising:
an inside surface and an outside surface, wherein the inside surface and the outside surface are joined together at a top and side sections of a perimeter edge of the inside surface and the outside surface;
an elastic band adjoined to a bottom section of the perimeter edge of the inside surface and the outside surface; and
the inside surface and the outside surface each having an opening therethrough.

2. The vehicle window covering of claim 1 further comprising a drawstring located at the atop and side sections of the perimeter edge, the drawingstring extending past the elastic band, and further including one or more drawstring locks.

3. The vehicle window covering of claim 1, wherein a surrounding border of the outside surface's opening is reinforced.

4. The vehicle window covering of claim 1, wherein a flap is adjoined to a surrounding border of the outside surface's opening.

5. The vehicle window covering of claim 1, wherein the outside surface's opening is positioned at a face of a character displayed on the outside surface.

6. The vehicle window covering of claim 1, further comprising a ring adjoined to a surrounding border of the outside surface's opening.

7. The vehicle window covering of claim 1, wherein the inside surface and the outside surface are inelastic fabric.

8. A method of covering a vehicle window, the method comprising the steps of:
placing a covering over a vehicle window door frame in its open position, the covering comprising an inside surface and an outside surface joined together at a top and side sections of a perimeter edge of the inside surface and the outside surface, and an elastic band adjoined to a bottom section of the perimeter edge of the inside surface and the outside surface, the inside surface and the outside surface each having an opening therethrough;
aligning the bottom section of the perimeter edge with a bottom section of a window of the vehicle window door frame;
cinching the top and side sections of the perimeter edge of the inside surface and the outside surface against the vehicle window door frame;
positioning the vehicle window door frame to a closed position; and
lowering the vehicle window to an open position.

9. The method of claim 8, wherein the step of cinching comprises tightening a drawstring located at the atop and side sections of the perimeter edge, the drawingstring extending past the elastic band, and further including one or more drawstring locks.

10. The method of claim 8 further comprising the step of covering the outside surface's opening.

11. The method of claim 8 further comprising the step of decreasing a size of the outside surface's opening.

12. The method of claim 8, wherein the inside surface and the outside surface are inelastic fabric.
